(19) United States
(12) Patent Application Publication
(10) Pub. No.: US 2024/0386165 A1
(43) Pub. Date: Nov. 21, 2024

(54) DIGITAL TWIN ANALYSIS FOR FIXTURE DESIGN BY ADDITIVE MANUFACTURING

(71) Applicant: INTERNATIONAL BUSINESS MACHINES CORPORATION, ARMONK, NY (US)

(72) Inventors: Jazmin Rodriguez Aguilera, Zapopan (MX); Carolina Garcia Delgado, Zapopan (MX); Mauro Marzorati, Lutz, FL (US); Jonathan Cottrell, Canandaigua, NY (US)

(21) Appl. No.: 18/320,246

(22) Filed: May 19, 2023

(51) Int. Cl. G06F 30/23

(52) U.S. Cl. CPC G06F 30/23; G06F 2113/10; G06F 2119/02

(57) ABSTRACT

Described are techniques for improved fixture design. The techniques include generating a digital twin of a new fixture using design information and usage characteristics of similar historical fixtures. The techniques further include simulating lifecycle usage of the new fixture using the digital twin. The techniques further include identifying a simulated failure point in the new fixture based on the simulated lifecycle usage. The techniques further include modifying the design information of the new fixture to mitigate the simulated failure point.

### BACKGROUND

The present disclosure relates to fixturing in manufacturing, and, more specifically, to digital twin analysis for fixture design by additive manufacturing.

Fixtures and jigs are used in manufacturing, fabrication, and/or assembly operations to properly position, orient, retain, and/or support one or more items during the manufacturing, fabrication, and/or assembly processes. Fixtures typically hold an item stationary while a tool moves about the item in the fixture while jigs typically enable movement of an item about a stationary tool. Fixtures and jigs can increase accuracy, precision, reliability, and interchangeability of manufactured, fabricated, and/or assembled components.

### SUMMARY

Aspects of the present disclosure are directed toward a method including generating a digital twin of a new fixture using design information and usage characteristics of similar historical fixtures. The method further includes simulating lifecycle usage of the new fixture using the digital twin. The method further includes identifying a simulated failure point in the new fixture based on the simulated lifecycle usage. The method further includes modifying the design information of the new fixture to mitigate the simulated failure point.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example computational environment implementing a fixture manager, in accordance with some embodiments of the present disclosure.

FIG. 2 illustrates a flowchart of an example method for fixture design, in accordance with some embodiments of the present disclosure.

FIG. 3 illustrates a flowchart of an example method for training a machine learning model for identifying usage characteristics of similar historical fixtures, in accordance with some embodiments of the present disclosure.

FIG. 4 illustrates a flowchart of an example method for downloading, deploying, metering, and billing usage of fixture design code, in accordance with some embodiments of the present disclosure.

FIG. 5 illustrates a block diagram of an example computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward fixturing in manufacturing, and, more specifically, to digital twin analysis for fixture design by additive manufacturing. While not limited to such applications, embodiments of the present disclosure may be better understood in light of the aforementioned context.

As discussed above, fixtures and jigs can increase accuracy, precision, reliability, and interchangeability of manufactured, fabricated, and/or assembled components. Although the present disclosure predominantly refers to fixtures, it should be understood that any reference to fixtures can likewise be applicable to jigs for the purposes of the present disclosure.

As understood by one skilled in the art, fixtures seldom receive the engineering analysis that manufactured parts do. In other words, fixtures are more likely to prematurely fail due to lifecycle loading events and/or environmental characteristics. Nonetheless, fixtures are an important component in any manufacturing line, and a damaged fixture can abruptly stop manufacturing. Accordingly, there is a need for robust and rapid fixture design.

Additive manufacturing is one mechanism for rapid fixture design. Additive manufacturing includes manufacturing techniques such as three-dimensional (3D) printing. In 3D printing, material is deposited layer-by-layer to create a component. 3D printing can be useful in applications such as prototype manufacturing and custom manufacturing of any number of parts. Further, 3D printing can be useful in applications requiring unique, delicate, complex, and/or interior geometries that are more efficient to manufacture using 3D printing than other manufacturing techniques. Accordingly, 3D printing is well suited to fixture fabrication due to various characteristics of fixtures such as, but not limited to, complicated geometries, disposable usage, customized designs, and/or rapid deployment.

Aspects of the present disclosure are directed to techniques for robust and rapid fixture design. In some embodiments, aspects of the present disclosure identify similar historical fixtures compared to a newly designed fixture. Additionally, aspects of the present disclosure retrieve usage characteristics of the similar historical fixtures. Aspects of the present disclosure can apply the usage characteristics of the similar historical fixtures to the newly designed fixture for purposes of accurately simulating loading (e.g., using Finite Element Analysis (FEA) software). Aspects of the present disclosure can utilize the simulated loading to identify a simulated failure point and automatically modify the newly designed fixture to mitigate the simulated failure. Aspects of the present disclosure can then provide the modified design of the new fixture to an additive manufacturing system for rapid prototyping, resulting in a fabricated fixture with increased performance relative to the original design.

Advantageously, aspects of the present disclosure can leverage historical fixtures and their usage characteristics to predict usage characteristics of a new fixture design. In some embodiments, the similar fixtures and their associated usage characteristics are identified by a machine learning model. Advantageously, this feature of the present disclosure enables automated prediction of usage characteristics for a new fixture design, thereby enabling relatively less experienced engineers to accurately and rapidly simulate lifecycle loading of a new fixture. Additionally, aspects of the present disclosure can automatically modify the fixture design using known design principles to mitigate a simulated failure (e.g., changing materials, modifying a dimensional attribute, adding a reinforcing feature, and/or removing a force concentration feature, etc.). Advantageously, this aspect of the present disclosure enables automated design improvements to the new fixture design, thereby enabling relatively less experienced engineers to rapidly develop robust fixture designs.

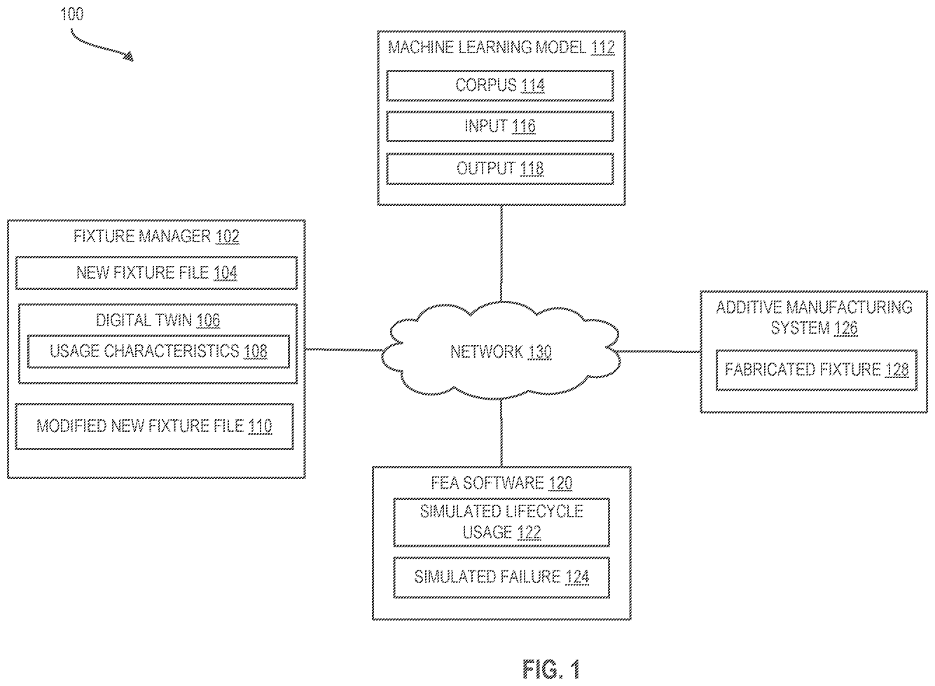

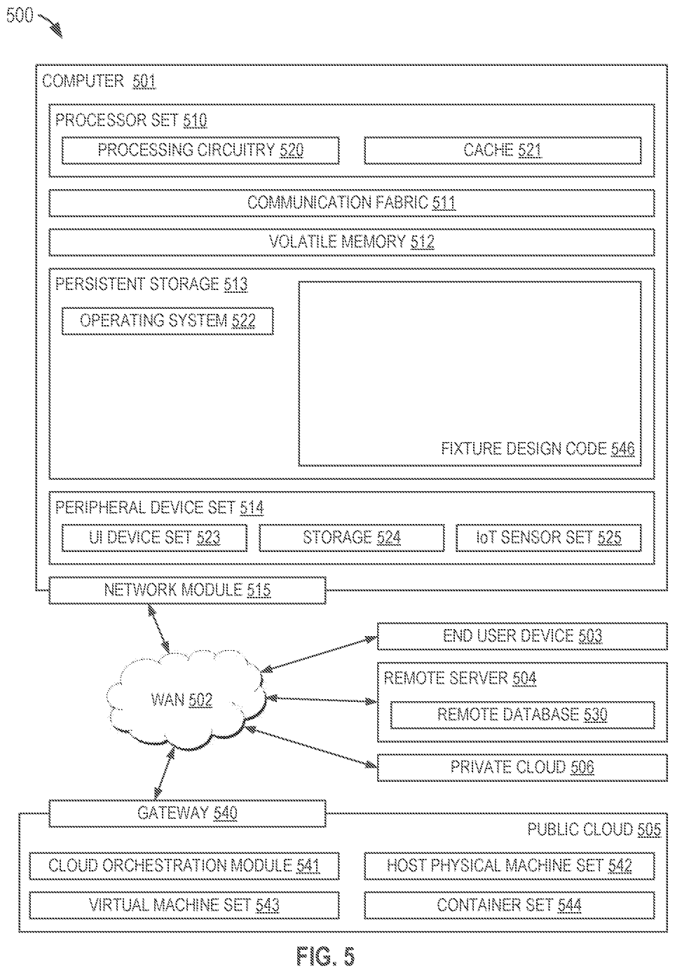

Referring now to the figures, FIG. 1 illustrates a block diagram of an example computational environment 100 implementing a fixture manager 102, in accordance with some embodiments of the present disclosure. Fixture manager 102 can be combination of hardware and software configured to generate a modified new fixture file 110 from new fixture file 104, where the modified new fixture file 110 exhibits improved performance (e.g., longer lifespan, higher reliability, fewer failures, etc.) relative to the new fixture file 104. In some embodiments, fixture manager 102 can be implemented as code executing on hardware (e.g., fixture design code 546 described hereafter with respect to FIG. 5).

Fixture manager 102 can be communicatively coupled to machine learning model 112, Finite Element Analysis (FEA) software 120, and additive manufacturing system 126 by one or more networks 130. The network 130 can be a local area network (LAN), a wide area network (WAN), an intranet, the Internet, or any other network 130 or group of networks 130 capable of continuously, semi-continuously, or intermittently connecting (directly or indirectly) the aforementioned components together.

Referring back to the fixture manager 102, it can be configured to ingest a new fixture file 104, input the new fixture file to the machine learning model 112, receive usage characteristics 108 of similar historical fixtures as output 118 from the machine learning model 112, create a digital twin 106 of the new fixture file 104 according to the usage characteristics 108, evaluate the digital twin 106 using FEA software 120 to determine a simulated failure 124 during simulated lifecycle usage 122, and generate a modified new fixture file 110 that is modified relative to the new fixture file 104 to mitigate the simulated failure 124. In some embodiments, the modified fixture file 110 is provided to the additive manufacturing system 126 to manufacture a fabricated fixture 128, where the fabricated fixture 128 exhibits improved performance relative to a fixture based on the new fixture file 104 and due to the modifications introduced by the modified new fixture file 110.

More specifically, fixture manager 102 can receive a new fixture file 104. New fixture file 104 can be a Computer-Aided Design (CAD) file such as a stereolithography (STL) file or another file useful for design purposes (e.g., drafted drawings, an image of a fixture, etc.). Fixture manager 102 can transmit the new fixture file 104 as input 116 to machine learning model 112.

Machine learning model 112 can be trained on a corpus 114 of historical fixtures and their associated usage characteristics. Usage characteristics can comprise loading characteristics (e.g., tension, compression, torsion, flexion, etc.), cycling characteristics (e.g., frequencies and/or durations of loading derived from mechanical, thermal, and/or hygrothermal loading), and/or environmental characteristics (e.g., temperatures, humidities, ultraviolet (UV) exposures, chemical exposures, etc.). Machine learning model 112 can comprise algorithms or models that are generated by performing supervised, unsupervised, or semi-supervised training on a dataset, and subsequently applying the generated algorithm or model to generate usage characteristics 108 from similar historical models as output 118 from the new fixture file 104 as input 116. In some embodiments, machine learning model 112 can be further configured to generate simulated failures 124 as output 118 from the new fixture file 104 as input 116. In some embodiments, machine learning model 112 can be further configured to generate modified new fixture file 110 as output 118 from new fixture file 104 as input 116.

Machine learning algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

Machine learning model 112 can be trained using corpus 114. The machine learning model 112 can then receive input 116. Input 116 can be, for example, the new fixture file 104. The machine learning model 112 can generate output 118 in response to receiving the input 116. The output 118 can comprise, for example, usage characteristics 108. Thus, output 118 can be used to enable accurate simulation of the lifecycle usage of the new fixture by FEA software 120.

After receiving output 118 from machine learning model 112, fixture manager 102 can create a digital twin 106 of the new fixture with the usage characteristics 108. The fixture manager 102 can then transmit the digital twin 106 with the usage characteristics to FEA software 120 for simulated lifecycle usage 122.

FEA software 120 can numerically solve differential equations to model engineering problems such as, for example, structural analysis, heat transfer, fluid flow, mass transport, and electromagnetic potential, among others. In general, FEA software 120 subdivides a model into smaller parts referred to as finite elements. The individual equations defining behaviors within and between the finite elements can be assembled to iteratively model (e.g., simulate) behaviors over time. During the simulated lifecycle usage 122, the FEA software 120 may identify a predicted failure 124. The simulated failure 124 can be, for example, a break, a crack, a fracture, a deformation, a debonding, a delamination, and/or an aesthetic issue.

Fixture manager 102 can evaluate the simulated failure 124 to determine a modification that can mitigate the simulated failure 124. For example, the fixture manager 102 can identify a location of the simulated failure 124 and a type of failure (e.g., a fracture caused by tension, compression, flexion, or torsion, for example). The fixture manager 102 can then apply a design modification to the new fixture such as changing a material, changing a thickness, adding a reinforcing feature (e.g., a rib), reducing or removing a force concentration feature (e.g., a corner), and the like. The fixture manager 102 can then apply the design change to the new fixture file 104 in order to generate a modified new fixture file 110. In some embodiments, the fixture manager 102 can subsequently create another digital twin 106 based on the modified new fixture file 110 and evaluate the simulated lifecycle usage 122 using the FEA software 120 for the modified new fixture file 110 (thereby determining whether the design change mitigated the simulated failure 124 or not). In some embodiments, the fixture manager 102 can provide the new fixture file 104 and the simulated failure 124 to the machine learning model 112 as input 116, and receive the modified new fixture file 110 as output 118 from the machine learning model 112.

In some embodiments, fixture manager 102 provides the modified new fixture file 110 to the additive manufacturing system 126 to create the fabricated fixture 128. Additive manufacturing (also referred to as three-dimensional (3D) printing) involves receiving a computer-aided design (CAD) model, slicing the CAD model into numerous layers, and then printing each layer sequentially to physically manufacture a component based on the CAD model. The printing can function by any number of techniques and processes that are configured to fuse, join, or otherwise combine material. For example, 3D printing can be performed by fused-filament fabrication (FFF), vat photopolymerization, stereolithography (SLA), material jetting, binder jetting, powder bed fusion, material extrusion, directed energy deposition, sheet lamination, and/or other 3D printing techniques.

A variety of materials can be used in manufacturing. These materials can include thermoplastics that are heated to a flowing point, deposited according to the layer-by-layer deposition protocol, and allowed to cool to solidify and bind with any adjacent material. In some situations, multiple materials are used, or similar materials are used with different modifiers, reinforcements, and/or fillers for color, strength, magnetism, and/or other customized aesthetic or structural properties.

The fabricated fixture 128 can be manufactured according to the modified new fixture file 110 by the additive manufacturing system 126. Accordingly, the fabricated fixture 128 can exhibit improved performance relative to a fixture fabricated from the new fixture file 104.

The configuration illustrated in FIG. 1 is an example configuration, and it should not be construed as limiting. For example, various disparate elements can be combined together, and various combined elements can be separated. For example, although FIG. 1 illustrates fixture manager 102 communicatively coupled to machine learning model 112, FEA software 120, and additive manufacturing system 126, in some embodiments, some or all of the aforementioned components are incorporated into a single system.

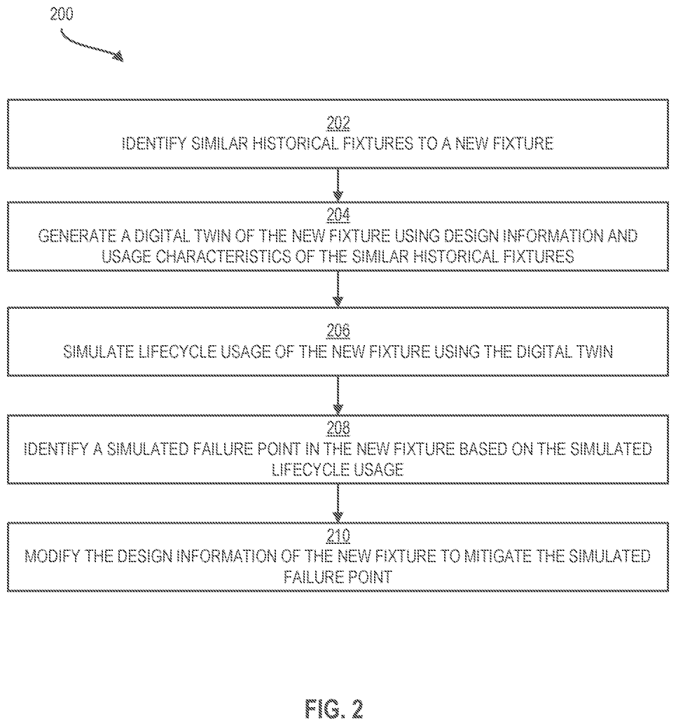

FIG. 2 illustrates a flowchart of an example method 200 for fixture design, in accordance with some embodiments of the present disclosure. In some embodiments, the method 200 can be implemented by a fixture manager (e.g., fixture manager 102 of FIG. 1), a computer (e.g., computer 501 implementing fixture design code 546), a server, a processor, or another configuration of hardware and/or software.

Operation 202 includes identifying similar historical fixtures to a new fixture. In some embodiments, operation 202 includes transmitting a new fixture file to a machine learning model as input and receiving usage characteristics related to the similar historical fixtures as output from the machine learning model.

Operation 204 includes generating a digital twin of the new fixture using design information and usage characteristics of the similar historical fixtures. The usage characteristics can include loading characteristics (e.g., tension, compression, torsion, flexion, etc.), cycling characteristics (e.g., frequencies and/or durations of loading derived from mechanical, thermal, and/or hygrothermal loading), and/or environmental characteristics (e.g., temperatures, humidities, ultraviolet (UV) exposures, chemical exposures, etc.). The digital twin can apply the usage characteristics to the new fixture for evaluation purposes.

Operation 206 includes simulating lifecycle usage of the new fixturing using the digital twin. In some embodiments, operation 206 utilizes FEA software to simulate the lifecycle usage of the new fixture according to the usage characteristics.

Operation 208 includes identifying a simulated failure point in the new fixture based on the simulated lifecycle usage. The simulated failure can be, for example, a break, a crack, a fracture, a deformation, a debonding, a delamination, and/or an aesthetic issue.

Operation 210 includes modifying the design information of the new fixture to mitigate the simulated failure point. The modification can be, for example, changing a material, changing a thickness, adding a reinforcing feature (e.g., a rib), reducing or removing a force concentration feature (e.g., a corner), and the like. In some embodiments, the modified design information is generated according to coded rules and algorithms. In some embodiments, the modified design information is generated by inputting the new fixture design and the simulated failure point to a machine learning model as input and receiving a modified new fixture design as output from the machine learning model.

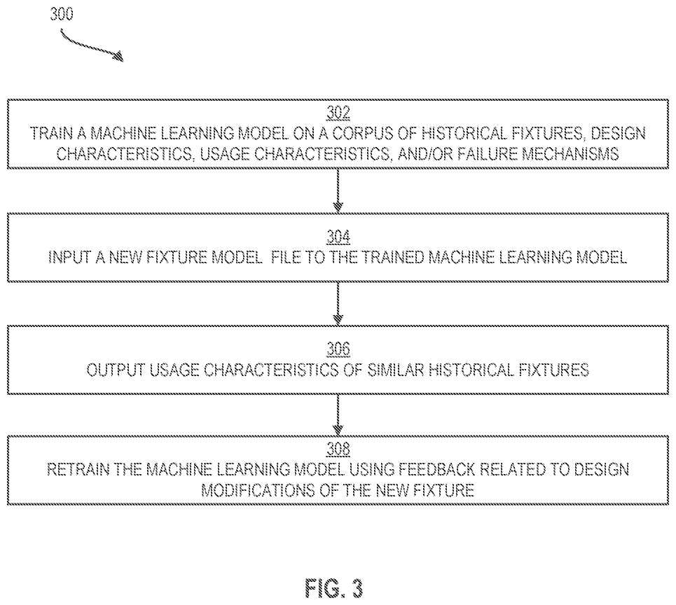

FIG. 3 illustrates a flowchart of an example method 300 for training a machine learning model for identifying usage characteristics of similar historical fixtures, in accordance with some embodiments of the present disclosure. In some embodiments, the method 300 can be implemented by a fixture manager (e.g., fixture manager 102 of FIG. 1), a computer (e.g., computer 501 implementing fixture design code 546), a server, a processor, or another configuration of hardware and/or software. In some embodiments, the method 300 is a sub-method of operation 202 of FIG. 2.

Operation 302 includes training a machine learning model on a corpus of historical fixture designs and their associated usage characteristics. In some embodiments, the same or another machine learning model can be trained on a corpus of historical fixture designs, their simulated or real failure mechanisms, and corresponding fixture design modifications to mitigate the simulated or real failure mechanisms. Operation 302 can utilize any of the machine learning algorithms previously discussed with respect to the machine learning model 112 of FIG. 1.

Operation 304 includes inputting a received new fixture file to the trained machine learning model. In some embodiments, operation 304 can include inputting a new fixture file together with a simulated failure.

Operation 306 includes outputting at least usage characteristics of similar historical fixtures. In some embodiments, operation 306 additionally outputs design information of the similar historical fixtures. In some embodiments, when operation 304 includes input of the new fixture file together with the simulated failure, operation 306 additionally outputs modified new fixture file design mitigating the simulated failure.

Operation 308 includes retraining the machine learning model using feedback related to design modifications of the new fixture. In some embodiments, the feedback can be user defined feedback indicating a user satisfaction with the design modifications. In some embodiments, the feedback can be based on whether or not a simulated or real failure is identified for a modified new fixture relative to the simulated failure identified for the new fixture in its original form.

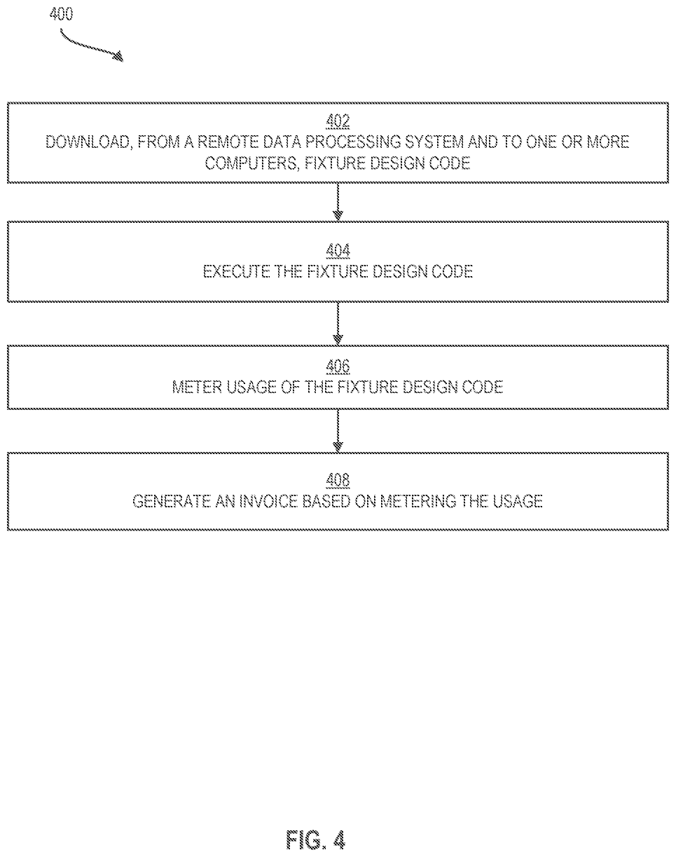

FIG. 4 illustrates a flowchart of an example method 400 for downloading, deploying, metering, and billing usage of fixture design code, in accordance with some embodiments of the present disclosure. In some embodiments, the method 400 can be implemented by a fixture manager (e.g., fixture manager 102 of FIG. 1), a computer (e.g., computer 501 implementing fixture design code 546), a server, a processor, or another configuration of hardware and/or software. In some embodiments, the method 400 is deployed contemporaneously with the method 200 of FIG. 2.

Operation 402 includes downloading, from a remote data processing system and to one or more computers (e.g., fixture manager 102 of FIG. 1, computer 501 of FIG. 5, etc.) fixture design code (e.g., fixture design code 546 of FIG. 5). Operation 404 includes executing the fixture design code. Operation 404 can include performing any of the methods and/or functionalities discussed herein. Operation 406 includes metering usage of the fixture design code. Usage can be metered by, for example, an amount of time the fixture design code is used, a number of servers and/or devices deploying the fixture design code, an amount of resources consumed by implementing the fixture design code, a number of modified new fixture files generated by usage of the fixture design code, a number of fabricated fixtures printed using the fixture design code, and/or other usage metering metrics. Operation 408 includes generating an invoice based on metering the usage.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 5 illustrates a block diagram of an example computing environment, in accordance with some embodiments of the present disclosure. Computing environment 500 contains an example of an environment for the execution of at least some of the computer code involved in performing the inventive methods, such as fixture design code 546. In addition to fixture design code 546, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and fixture design code 546, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in fixture design code 546 in persistent storage 513.

COMMUNICATION FABRIC 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface type operating systems that employ a kernel. The code included in fixture design code 546 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any software configured to perform any portion of the methods described previously and/or implement any of the functionalities described previously) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

A non-limiting list of examples are provided hereinafter to demonstrate some aspects of the present disclosure. Example 1 is computer-implemented method. The method includes generating a digital twin of a new fixture using design information and usage characteristics of similar historical fixtures; simulating lifecycle usage of the new fixture using the digital twin; identifying a simulated failure point in the new fixture based on the simulated lifecycle usage; and modifying the design information of the new fixture to mitigate the simulated failure point.

Example 2 includes the features of Example 1. In this example, the usage characteristics of the historical fixtures include loading characteristics, cycling characteristics, and environmental characteristics.

Example 3 includes the features of any one of Examples 1 to 2. In this example, the method further comprises: identifying the similar historical fixtures by: inputting the design information for the new fixture to a machine learning model, wherein the machine learning model is trained on a corpus of historical fixtures and corresponding usage characteristics; and receiving, as output from the machine learning model, the usage characteristics of the historical fixtures that are similar to the design information for the new fixture.

Example 4 includes the features of any one of Examples 1 to 3. In this example, the design information for the new fixture comprises a Computer Aided Design (CAD) model file of the new fixture.

Example 5 includes the features of any one of Examples 1 to 4. In this example, simulating the lifecycle usage of the new fixture utilizes simulation software based on Finite Element Analysis (FEA).

Example 6 includes the features of any one of Examples 1 to 5. In this example, modifying the design information of the new fixture includes at least one selected from a group consisting of: changing a material composition of the new fixture in an area of the simulated failure point, changing a dimensional attribute of the new fixture in an area of the simulated failure point, adding a reinforcing ribbing to the new fixture in an area of the simulated failure point, and reducing a force concentration feature of the new fixture in an area of the simulated failure point.

Example 7 includes the features of any one of Examples 1 to 6. In this example, the method further comprises: fabricating the new fixture according to the modified design information using additive manufacturing.

Example 8 is a system. The system includes one or more computer readable storage media storing program instructions; and one or more processors which, in response to executing the program instructions, are configured to perform a method according to any one of Examples 1 to 7, including or excluding optional features.

Example 9 is a computer program product. The computer program product includes one or more computer readable storage media, and program instructions collectively stored on the one or more computer readable storage media, the program instructions comprising instructions configured to cause one or more processors to perform a method according to any one of Examples 1 to 7, including or excluding optional features.

What is claimed is:

1. A computer-implemented method comprising:
generating a digital twin of a new fixture using design information and usage characteristics of similar historical fixtures;
simulating lifecycle usage of the new fixture using the digital twin;
identifying a simulated failure point in the new fixture based on the simulated lifecycle usage; and
modifying the design information of the new fixture to mitigate the simulated failure point.

2. The method of claim 1, wherein the usage characteristics of the historical fixtures include loading characteristics, cycling characteristics, and environmental characteristics.

3. The method of claim 1, wherein the method further comprises:
identifying the similar historical fixtures by:
inputting the design information for the new fixture to a machine learning model, wherein the machine learning model is trained on a corpus of historical fixtures and corresponding usage characteristics; and
receiving, as output from the machine learning model, the usage characteristics of the historical fixtures that are similar to the design information for the new fixture.

4. The method of claim 1, wherein the design information for the new fixture comprises a Computer Aided Design (CAD) model file of the new fixture.

5. The method of claim 1, wherein simulating the lifecycle usage of the new fixture utilizes simulation software based on Finite Element Analysis (FEA).

6. The method of claim 1, wherein modifying the design information of the new fixture includes changing a material composition of the new fixture in an area of the simulated failure point.

7. The method of claim 1, wherein modifying the design information of the new fixture includes changing a dimensional attribute of the new fixture in an area of the simulated failure point.

8. The method of claim 1, wherein modifying the design information of the new fixture includes adding a reinforcing ribbing to the new fixture in an area of the simulated failure point.

9. The method of claim 1, wherein modifying the design information of the new fixture includes reducing a force concentration features of the new fixture in an area of the simulated failure point.

10. The method of claim 1, further comprising:
fabricating the new fixture according to the modified design information using additive manufacturing.

11. A system comprising:
one or more computer readable storage media storing program instructions; and
one or more processors which, in response to executing the program instructions, are configured to perform a method comprising:
generating a digital twin of a new fixture using design information and usage characteristics of similar historical fixtures;
simulating lifecycle usage of the new fixture using the digital twin;
identifying a simulated failure point in the new fixture based on the simulated lifecycle usage; and
modifying the design information of the new fixture to mitigate the simulated failure point.

12. The system of claim 11, wherein the one or more computer readable storage media store additional program instructions configured to cause the one or more processors to perform the method further comprising:
identifying the similar historical fixtures by:
inputting the design information for the new fixture to a machine learning model, wherein the machine learning model is trained on a corpus of historical fixtures and corresponding usage characteristics; and
receiving, as output from the machine learning model, the usage characteristics of the historical fixtures that are similar to the design information for the new fixture.

13. The system of claim 11, wherein modifying the design information of the new fixture includes changing a material composition of the new fixture in an area of the simulated failure point.

14. The system of claim 11, wherein modifying the design information of the new fixture includes changing a dimensional attribute of the new fixture in an area of the simulated failure point.

15. The system of claim 11, wherein modifying the design information of the new fixture includes at least one selected from a group consisting of:
adding a reinforcing feature to the new fixture in an area of the simulated failure point, and
reducing a force concentration feature of the new fixture in an area of the simulated failure point.

16. A computer program product comprising one or more computer readable storage media, and program instructions collectively stored on the one or more computer readable storage media, the program instructions comprising instructions configured to cause one or more processors to perform a method comprising:
generating a digital twin of a new fixture using design information and usage characteristics of similar historical fixtures;
simulating lifecycle usage of the new fixture using the digital twin;
identifying a simulated failure point in the new fixture based on the simulated lifecycle usage; and
modifying the design information of the new fixture to mitigate the simulated failure point.

17. The computer program product of claim 16, wherein the one or more computer readable storage media store additional program instructions configured to cause the one or more processors to perform the method further comprising:
identifying the similar historical fixtures by:
inputting the design information for the new fixture to a machine learning model, wherein the machine learning model is trained on a corpus of historical fixtures and corresponding usage characteristics; and
receiving, as output from the machine learning model, the usage characteristics of the historical fixtures that are similar to the design information for the new fixture.

18. The computer program product of claim 17, wherein modifying the design information of the new fixture includes changing a material composition of the new fixture in an area of the simulated failure point.

19. The computer program product of claim 17, wherein modifying the design information of the new fixture includes changing a dimensional attribute of the new fixture in an area of the simulated failure point.

20. The computer program product of claim 17, wherein modifying the design information of the new fixture includes at least one selected from a group consisting of:
adding a reinforcing feature to the new fixture in an area of the simulated failure point, and
reducing a force concentration feature of the new fixture in an area of the simulated failure point.
